(19) United States
(12) Patent Application Publication
(10) Pub. No.: US 2025/0304487 A1
(43) Pub. Date: Oct. 2, 2025

(54) ALKALI METAL CONTAINING GLASSES WITH LOW ALUMINA CONTENT

(71) Applicant: CORNING INCORPORATED, CORNING, NY (US)

(72) Inventors: Venkatesh Botu, Corning, NY (US); Franklin Langlang Lee, Green Brook, NJ (US); Alexandra Lai Ching Kao Andrews Mitchell, Ithaca, NY (US)

(21) Appl. No.: 18/706,498

(22) PCT Filed: Oct. 28, 2022
(86) PCT No.: PCT/US2022/048171

§ 371 Date: May 1, 2024

Related U.S. Application Data
(60) Provisional application No. 63/276,092, filed on Nov. 5, 2021.

(51) Int. Cl. C03C 3/091; G02F 1/1333

(52) U.S. Cl. CPC C03C 3/091; G02F 1/133331

(57) ABSTRACT

According to the embodiments described herein glass composition comprises: (i) about 50 mol. % to about 73 mol. % SiO₂; (ii) greater than 0 mol. % to about 1.25 mol. % Al₂O₃; (iii) about 5 mol. % to about 20 mol. % B₂O₃; (iv) about 3.5 mol. % to about 17 mol. % K₂O; (i) 0 mol. % to about 20 mol. % MgO; (iv) 0 mol. % to about 20 mol. % CaO; (vi) 0 mol. % to about 20 mol. % SrO; and (vii) 0 mol. % to about 20 mol. % BaO; wherein the molar ratio (K₂O+Rb₂O+Cs₂O+MgO+CaO+SrO+BaO)/Al₂O₃≥10.

### CROSS-REFERENCE TO RELATED APPLICATIONS

This application claims the benefit of priority under 35 U.S.C. § 119 of U.S. Provisional Application No. 63/276,092 filed Nov. 5, 2021, the content of which is incorporated herein by reference in its entirety.

### FIELD

The disclosure relates to glass composition generally. More particularly, the disclosed subject matter relates to glass compositions comprising alkali metal and suitable for use in display applications.

### BACKGROUND

Flat or curved substrates made of an optically transparent material such as glass are used for flat panel display, photovoltaic devices, and other suitable applications. In addition to the requirement for optical clarity, glass compositions need to meet different challenges depending on fabrication process and the applications.

Glass articles, such as cover glasses and glass backplanes, are employed in both consumer and commercial electronic devices as LCD and LED displays and computer monitors.

The production of liquid crystal displays (LCDs) such as active matrix liquid crystal display devices (AMLCDs) is complex, and the properties of the substrate glass are important. The glass substrates used in the production of AMLCD devices need to have their physical dimensions tightly controlled. The downdraw sheet drawing processes and, in particular, the fusion process, are capable of producing glass sheets that can be used as substrates without requiring costly post-forming finishing operations such as lapping and polishing. However, the fusion process places rather severe restrictions on the glass properties, which require relatively high liquidus viscosities.

In the liquid crystal display field, thin film transistors (TFTs) may be based on poly-crystalline silicon (p-Si) or amorphous silicon (a-Si). Amorphous silicon offers advantages such as lower processing temperature. Sometimes poly-crystalline silicon is preferably used because of their ability to transport electrons more effectively. Poly-crystalline based silicon transistors are characterized as having a higher mobility than those based on amorphous-silicon based transistors. This allows the manufacture of smaller and faster transistors, which ultimately produces brighter and faster displays. One problem with poly-crystalline silicon (p-Si) or amorphous silicon (a-Si) transistors is that their coefficients of thermal expansion (CTEs) are higher than CTEs of the typical display glasses at low processing temperatures, and such CTE mismatches can cause delamination of TFT from the glass substrates when the device undergoes thermal cycling. These temperatures range from 450° C. to 600° C. compared to the 350° C. peak temperatures employed in the manufacture of a-Si transistors.

The glass compositions used for display applications need to have good thermal and mechanical properties, and dimensional stability satisfying the processing and performance requirements. In addition, diffusion of metal ions into the thin film transistors may cause damages to the transistors. Such diffusion needs to be minimized or eliminated.

### SUMMARY

The present disclosure provides a glass composition, a glass substrate comprising such a glass composition, and a display device comprising such a glass composition or a glass substrate having such a glass composition.

In accordance with some embodiments, a glass composition comprises: about 50 mol. % to about 73 mol. % SiO₂;
greater than 0 mol. % to about 1.25 mol. % Al₂O₃;
about 5 mol. % to about 20 mol. % B₂O₃;
about 3.5 mol. % to about 17 mol. % K₂O;
0 mol. % to about 20 mol. % MgO;
0 mol. % to about 20 mol. % CaO;
0 mol. % to about 20 mol. % SrO;
0 mol. % to about 20 mol. % BaO; and
wherein the molar ratio (K₂O+Rb₂O+Cs₂O+MgO+CaO+SrO+BaO)/Al₂O₃≥10.

For example, in some embodiments: 1000000≥K₂O+Rb₂O+Cs₂O+MgO+CaO+SrO+BaO)/Al₂O₃≥10. Furthermore, according with the exemplary embodiments, the glass composition further comprises about 0 mol. % to about 1 mol. % SnO₂, for example 0.05 mol. % to 0.5 mol. % SnO₂.

In accordance with some embodiments, a glass composition comprises:
about 50 mol. % to about 73 mol. % SiO₂ (e. g., 50 mol. % to 68.5 mol. % SiO₂)
greater than 0 mol. % to about 1.25 mol. % Al₂O₃,
about 5 mol. % to about 20 mol. % B₂O₃,
about 3.5 mol. % to about 17 mol. % K₂O,
0 mol. % to about 19.9 mol. % MgO,
0 mol. % to about 15.7 mol. % CaO,
0 mol. % to about 16.5 mol. % SrO, and
0 mol. % to about 16.5 mol. % BaO,

In accordance with some embodiments, a glass composition comprises:
about 50 mol. % to about 73 mol. % SiO₂,
greater than 0.005 mol. % to about 1.25 mol. % Al₂O₃,
about 5 mol. % to about 20 mol. % B₂O₃,
about 3.5 mol. % to about 17 mol. % K₂O₃,
0 mol. % to about 19.9 mol. % MgO,
0 mol. % to about 15.7 mol. % CaO,
0 mol. % to about 16.5 mol. % SrO, and
0 mol. % to about 16.5 mol. % BaO,

In accordance with some embodiments, a glass composition further comprises about 0 mol. % to about 1 mol. % SnO₂, for example 0.05 mol. % to 0.5 mol. % SnO₂.

In accordance with some embodiments, a glass composition further comprises about 2 mol. % to about 20 mol. % of R₂O, which is an alkali metal oxide selected from the group consisting of K₂O, Rb₂O, Cs₂O, and a combination thereof. In accordance with some embodiments. R₂O is K₂O.

In accordance with some embodiments, the % molar ratio of alkali metal oxide to Al₂O₃ is at least 10, and in some embodiments ≥15 and ≥20. In some embodiments, the % molar ratio of alkali metal oxide to Al₂O₃ is: 10≤R₂O/Al₂O₃≤1000, 10≤R₂O/Al₂O₃≤500, 10≤R₂O/Al₂O₃≤100, or 20≤R₂O/Al₂O₃, for example: 10≤R₂O/Al₂O₃≤50; 15<R₂O/Al₂O₃≤50; 20≤R₂O/Al₂O₃≤50; 15≤R₂O/Al₂O₃≤45; or 20≤R₂O/Al₂O₃≤45.

In accordance with some embodiments, the glass composition comprises about 10 mol. % to about 30 mol. % RO in total (e.g., 10-25 mol % or 10 to 20 mol %), and RO comprises MgO, CaO, SrO, BaO, optionally ZnO, and any combination thereof. For example, in some embodiments, the glass composition comprises about 12 mol. % to about 30 mol. % RO in total, or 15 mol. % to about 25 mol RO in total.

In accordance with some embodiments, the % molar ratio of (RO+R₂O)/Al₂O₃≥10. In some embodiments, 5000≥(RO+R₂O)/Al₂O₃>10. In accordance with some embodiments, the glass composition comprises about 12 mol. % to about 30 mol. % RO in total, or 15 mol. % to about 25 mol RO in total.

In accordance with some embodiments, (i) 1000≥RO/Al₂O₃≥20; and (ii) 1000≥R₂O/Al₂O₃≥20.

In accordance with some embodiments, the glass composition has Coefficient of Thermal Expansion (CTE) of at least 78×10⁻⁷° C. at 300° C. and/or softening point not greater than 800° C.

In accordance with some embodiments, a glass composition comprises:
about 50 mol. % to about 70 mol. % SiO₂,
greater than 0 mol. % to about 1 mol. % Al₂O₃,
about 9 mol. % to about 17 mol. % B₂O₃,
about 3.5 mol. % to about 15 mol. % K₂O,
0 mol. % to about 19.9 mol. % MgO,
0 mol. % to about 15.7 mol. % CaO,
0 mol. % to about 16.5 mol. % SrO, and
0 mol. % to about 16.5 mol. % BaO.

In accordance with some embodiments, a glass composition comprises:
about 50 mol. % to about 70 mol. % SiO₂,
greater than 0.001 mol. % to about 1 mol. % Al₂O₃,
about 9 mol. % to about 17 mol. % B₂O₃,
about 3.5 mol. % to about 15 mol. % K₂O,
0 mol. % to about 19.9 mol. % MgO,
0 mol. % to about 15.7 mol. % CaO,
0 mol. % to about 16.5 mol. % SrO, and
0 mol. % to about 16.5 mol. % BaO.

In accordance with some embodiments, a glass composition comprises:
about 50 mol. % to about 70 mol. % SiO₂,
greater than 0.005 mol. % to about 0.55 mol. % Al₂O₃,
about 9 mol. % to about 17 mol. % B₂O₃,
about 3.5 mol. % to about 15 mol. % K₂O,
0 mol. % to about 19.9 mol. % MgO,
0 mol. % to about 15.7 mol. % CaO,
0 mol. % to about 16.5 mol. % SrO, and
0 mol. % to about 16.5 mol. % BaO.

In some embodiments, an exemplary glass composition comprises:
about 50 mol. % to about 68.5 mol. % SiO₂,
   greater than 0 mol. % to about 1.25 mol. % Al₂O₃ (e.g., 0.001 to 1 mol. % Al₂O₃, or 0.005 mol. % to 0.06 mol. % Al₂O₃),
   about 5 mol. % to about 20 mol. % B₂O₃ (e.g., 9 mol. % to about 17 mol. % B₂O₃),
   about 3.5 mol. % to about 17 mol. % K₂O₃ (e.g., 3.5 mol. % to about
15 mol. % K₂₀₃);
0 mol. % to about 19.9 mol. % MgO,
0 mol. % to about 15.7 mol. % CaO,
0 mol. % to 16.5 mol. % MgO), and
0 mol. % to about 16.5 mol. % BaO; and
   the molar ratio of (K₂O+Rb₂O+Cs₂O+MgO+CaO+SrO+BaO)/Al₂O₃ is greater than 10, preferably greater than 20, for example 20 to 5000, or 20 to 2750, or 20 to 1000. In some embodiments the glass composition comprises no more than 2 mol. % of other components (e.g., no more than 1 mol. %, or even no more than 0.5 mol. %).

In some embodiments, an exemplary glass composition comprises:
about 50 mol. % to about 68.5 mol. % SiO₂,
greater than 0 mol. % to about 0.25 mol. % Al₂O₃,
about 9 mol. % to about 17 mol. % B₂O₃,
about 2 mol. % to about 18 mol. % of R₂O, wherein R₂O is an alkali metal oxide selected from the group consisting of K₂O, Rb₂O, Cs₂O, and a combination thereof;
0 mol. % to about 12 mol. % MgO;
0 mol. % to about 10 mol. % CaO;
0 mol. % to about 16.5 mol. % SrO;
0 mol. % to about 16.5 mol. % BaO, and
   wherein the glass composition comprises about 10 mol. % to about 70 mol. % RO in total, and RO is selected from the group consisting MgO, CaO, SrO, BaO, and any combination thereof.

In some embodiments the glass composition comprises no more than 2 mol. % of other components (e.g., no more than 1 mol. %, or even no more than 0.5 mol. %).

Examples of a glass article include, but are not limited to a panel, a substrate, a cover, a backplane, and any other components used in an electronic device for display applications. For example, in some embodiments, the glass composition or the glass substrate is a cover or backplane in an electronic device. In some embodiments, thin film resistors are built on or in contact with the glass composition. Examples of the electronic devices include, but are not limited to, liquid crystal display (LCD), light emitting diode (LED) display, computer monitors, automated teller machines (ATMs), touch screen, and photovoltaic devices.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to +10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 and 4-5”, “1-3 and 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

The present disclosure provides a glass composition. The present disclosure also provides a glass substrate or article comprising such a glass composition, and a display device comprising such a glass composition or a glass substrate having such a glass composition. Such a glass composition comprises the ingredients as described herein, including a low content of Al₂O₃, and an alkali metal oxide (R₂O), for example K₂O, Rb₂O, Cs₂O, or a combination thereof. As described herein, the inventors have surprisingly found that such a glass composition comprising high content of alkali metal oxide(s) and a low content of Al₂O₃ (<1.25 mol. %, for example: <1 mol. %, <0.75 mol. %, or <0.6 mol. %) provides low liquidus temperature, high liquidus viscosity, a medium to high coefficient of thermal expansion, and good mechanical properties. Preferably, the % molar ratio of alkali metal oxide to Al₂O₃ is at least 10, and in some embodiments ≥15 and ≥20. In some embodiments, the % molar ratio of alkali metal oxide to Al₂O₃ is: 10≤R₂O/Al₂O₃≤1000; 10≤R₂O/Al₂O₃≤500, 10≤R₂O/Al₂O₃≤100; 20<R₂O/Al₂O₃≤ 500; 20≤R₂O/Al₂O₃≤100; 10≤R₂O/Al₂O₃≤50; 15<R₂O/Al₂O₃≤50; 20≤R₂O/Al₂O₃≤50; 15≤R₂O/Al₂O₃≤45; 20≤R₂O/Al₂O₃≤45; 25≤R₂O/Al₂O₃≤42, or 26≤R₂O/Al₂O₃≤41.

Unless expressly indicated otherwise, the term “glass article” or “glass” used herein is understood to encompass any object made wholly or partly of glass. Glass articles include monolithic substrates, or laminates of glass and glass, glass and non-glass materials, glass and crystalline materials, and glass and glass-ceramics (which include an amorphous phase and a crystalline phase).

The glass article such as a glass panel may be flat or curved and is transparent or substantially transparent. As used herein, the term “transparent” is intended to denote that the article, at a thickness of approximately 1 mm, has a transmission of greater than about 85% in the visible region of the spectrum (400-700 nm). For instance, an exemplary transparent glass panel may have greater than about 85% transmittance in the visible light range, such as greater than about 90%, greater than about 95%, or greater than about 99% transmittance, including all ranges and subranges therebetween. According to various embodiments, the glass article may have a transmittance of less than about 50% in the visible region, such as less than about 45%, less than about 40%, less than about 35%, less than about 30%, less than about 25%, or less than about 20%, including all ranges and subranges therebetween. In certain embodiments, an exemplary glass panel may have a transmittance of greater than about 50% in the ultraviolet (UV) region (100-400 nm), such as greater than about 55%, greater than about 60%, greater than about 65%, greater than about 70%, greater than about 75%, greater than about 80%, greater than about 85%, greater than about 90%, greater than about 95%, or greater than about 99% transmittance, including all ranges and subranges therebetween.

In some embodiments, the glass article that includes glass compositions described herein may be strengthened by utilizing a mismatch of the coefficient of thermal expansion between portions of the article to create a compressive stress region and a central region exhibiting a tensile stress.

In some embodiments, the glass compositions described herein are alkaline earth boro-silicate glass compositions, which generally include a combination of SiO₂, B₂O₃, a small amount of Al₂O₃, at least one alkaline earth oxide, and alkali metal oxide including at least one of K₂O, Rb₂O, and Cs₂O. The glass compositions described herein have an amorphous structure. Crystalline or polycrystalline structures may be also made using the compositions.

The term “softening point,” as used herein, refers to the temperature at which the viscosity of the glass composition is 1×10^{7.6} poise. The softening point is measured using the method of parallel plate viscosity (PPV).

The term “annealing point,” as used herein, refers to the temperature at which the viscosity of the glass composition is 1×10^{13.18} poise.

The terms “strain point” and “Tₛₜᵣₐᵢₙ” as used herein, refers to the temperature at which the viscosity of the glass composition is 1014.68 poise.

The liquidus temperature of a glass (T_{lig}) is the temperature (° C.) above which no crystalline phases can coexist in equilibrium with the glass. The liquidus viscosity is the viscosity of a glass at the liquidus temperature.

The term “CTE,” as used herein, refers to the coefficient of thermal expansion of the glass composition over a temperature range from about room temperature (RT, 22° C.) to about 300° C.

In the embodiments of the glass compositions described herein, the concentrations of constituent components (e.g., SiO₂, Al₂O₃, and the like) are specified in mole percent (mol. %) on an oxide basis, unless otherwise specified.

The terms “free” and “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.01 mol. %.

In accordance with some embodiments, a glass composition comprises: about 50 mol. % to about 73 mol. % SiO₂;
greater than 0 mol. % to about 1.25 mol. % Al₂O₃;
about 5 mol. % to about 20 mol. % B₂O₃;
about 3.5 mol. % to about 17 mol. % K₂O;
0 mol. % to about 20 mol. % MgO;
0 mol. % to about 20 mol. % CaO;
0 mol. % to about 20 mol. % SrO;
0 mol. % to about 20 mol. % BaO; and
   wherein the molar ratio (K₂O+Rb₂O+Cs₂O+MgO+CaO+SrO+BaO)/Al₂O₃≥10. For example, in some embodiments: 1000000≥K₂O+Rb₂O+Cs₂O+MgO+CaO+SrO+BaO)/Al₂O₃>10. In some embodiments the glass composition comprises no more than 2 mol. % of other components. For example more than 1 mol. % of other components. Furthermore, according in some embodiments, the glass composition further comprises about 0 mol. % to about 1 mol. % SnO₂, for example 0.05 mol. % to 0.5 mol. % SnO₂.

In accordance with some embodiments, a glass composition comprises:
about 50 mol. % to about 73 mol. % SiO₂,
   greater than 0 mol. % Al₂O₃ to about 1.25 mol. % Al₂O₃ (e.g., 0.005 mol. %, 0.007 mol. %, 0.01 mol. %, 0.25 mol. %, 0.5 mol. %, 0.6 mol. %, 0.75 mol. %, 1 mol. %, or 1.2 mol. %);
about 5 mol. % to about 20 mol. % B₂O₃,
about 2 mol. % to about 20 mol. % of R₂O, which is an alkali metal oxide selected from the group consisting of K₂O, Rb₂O, Cs₂O, and a combination thereof,
0 mol. % to about 19.9 mol. % MgO,
0 mol. % to about 15.7 mol. % CaO,
0 mol. % to about 16.5 mol. % SrO, and
0 mol. % to about 16.5 mol. % BaO.

In accordance with some embodiments, a glass composition comprises:
about 50 mol. % to about 73 mol. % SiO₂,
greater than 0 mol. % to about 1.25 mol. % Al₂O₃,
about 5 mol. % to about 20 mol. % B₂O₃,
about 2 mol. % to about 20 mol. % of R₂O, which is an alkali metal oxide selected from the group consisting of K₂O, Rb₂O, Cs₂O, and a combination thereof,
0 mol. % to about 12 mol. % MgO,
0 mol. % to about 10 mol. % CaO,
0 mol. % to about 1.5 mol. % SrO, and
0 mol. % to about 5 mol. % BaO.

For example, in some embodiments, the glass composition comprises:
about 50 mol. % to about 70 mol. % SiO₂,
greater than 0 mol. % to about 0.55 mol. % Al₂O₃,
about 9 mol. % to about 17 mol. % B₂O₃,
about 3.5 mol. % to about 16 mol. % K₂O₃,
0 mol. % to about 19.9 mol. % MgO,
0 mol. % to about 15.7 mol. % CaO,
0 mol. % to about 16.5 mol. % SrO,
0 mol. % to about 16.5 mol. % BaO; and
0 mol. % to 1 mol. % SnO₂.

For example, in some embodiments, the glass composition comprises:
about 50 mol. % to about 70 mol. % SiO₂,
greater than 0 mol. % to about 0.55 mol. % Al₂O₃,
about 9 mol. % to about 17 mol. % B₂O₃,
about 3.5 mol. % to about 15 mol. % K_{203,}
0 mol. % to about 19.9 mol. % MgO,
0 mol. % to about 15.7 mol. % CaO,
0 mol. % to about 16.5 mol. % SrO,
0 mol. % to about 16.5 mol. % BaO, and
no more than 1 mol. % of other components.

According to some of the exemplary embodiments described herein the glass composition comprises about 10 mol. % to about 30 mol. % RO in total (e.g., 10-25 mol %, or 10 to 20 mol %) and RO comprises MgO, CaO, SrO, BaO, optionally ZnO, and any combination thereof. According to some of the exemplary embodiments described herein the glass composition comprises about 10 mol. % to about 30 mol. % RO in total (e.g., 10-25 mol %, or 10 to 20 mol %) and RO is selected from a group consisting of MgO, CaO, SrO, BaO and ZnO, and any combination thereof. For example, in some embodiments the glass composition comprises about 12 mol. % to about 30 mol. % RO in total, or 15 mol. % to about 25 mol % RO in total.

In the embodiments of the glass compositions described herein, SiO₂ is the largest constituent of the composition and, as such, is the primary constituent of the glass network.

In the glass composition, SiO₂ is present in any suitable range. Examples of a suitable range include, but are not limited to, about 50 mol. % to about 70 mol. %, about 51 mol. % to about 69 mol. %, about 51 mol. % to about 68.5 mol. %, for example 51 mol. %, 52 mol. %, 53 mol. %, 54 mol. %, 55 mol. %, 56 mol. %, 57 mol. %, 58 mol. %, 60 mol. %, 62 mol. %, 64 mol. %, 65 mol. %, 66 mol. %, 68 mol. %, 68.3 mol. %, 68.5 mol. %, or therebetween.

The glass compositions described herein further include Al₂O₃, at a very low content. In some embodiments, Al₂O₃ has a content of less than 1.25 mol. %, or even less than about 1 mol. %, or less than 0.75 mol. %. In some embodiments, Al₂O₃ has a content of less than 0.6 mol. %, or even less than about 0.55 mol. %. Examples of a suitable range of Al₂O₃ include, but are not limited to, 0.001 mol. % to about 1.25 mol. %, 0.001 mol. % to about 1 mol. %, 0.0025 mol. % to about 1 mol. %, about 0.005 mol. % to about 1.25 mol. %, about 0.005 mol. % to about 1 mol. %, about 0.05 mol. % to about 0.55 mol. %, about 0.1 mol. % to about 0.51 mol. %, about 0.2 mol. % to about 0.5 mol. %, about 0.25 mol. % to about 0.52 mol. %, about 0.3 mol. % to about 0.5 mol. %, or about 0.4 mol. % to about 0.5 mol. %.

The glass compositions in the embodiments described herein also include alkali metal oxides. Preferably, the glass compositions described herein include at least one of K₂O, Rb₂O, Cs₂O, or a combination thereof. In some embodiments, the alkali metal oxide (R₂O) is K₂O. Preferably, the alkali metal oxide (R₂O) is not Na₂O. In some embodiments, embodiments, the alkali metal oxide (R₂O) is K₂O. The alkali metal oxide (R₂O) has a content in any suitable range. Examples of a suitable range of R₂O include, but are not limited to, about 2.5 mol. % to about 15 mol. %, about 3 mol. % to about 15 mol. %, about 3.5 mol. % to about 14 mol. %.

The addition of alkali oxides such as K₂O to the glass compositions would increase the average coefficient of thermal expansion (CTE) of the resultant glass. However, the inventors of the present disclosure have surprisingly found that the glass composition having alkali oxides in combination with a low content of Al₂O₃ has intermediate to high coefficient of thermal expansion (CTE). Meanwhile, such a combination also decreases the liquidus temperature of the glass composition and increases the liquidus viscosity of the glass composition.

The glass composition may further comprise 0 mol. % to about 2 mol. % of Li₂O. Li₂O is optional. For example, the content of Li₂O may be 0 mol. % to about 1 mol. %, or 0.1 mol. % to about 2 mol. % in the glass composition in some embodiments. When Li₂O is present, the total content of alkaline metal oxide K₂O, Rb₂O, Cs₂O and Li₂O is about 3 mol. % to about 15 mol. %. In some embodiments, the glass composition is substantially free of Li₂O and any other ingredients containing Li. In some embodiments, preferably, no Li₂O is present because it may diffuse too quickly in some of the compositions, which may be unsuitable for some applications.

K₂O, Rb₂O, Cs₂O or a combination thereof is used as the primary alkali oxide ponstituent as the relatively large ionic radius of K, Rb or Cs, compared to Na or Li, decreases the diffusivity of the alkali metal in the glass. Low diffusivity is very important when the glass composition is used to form backplanes for displays because the diffusion of alkali metal from the glass to thin film transistors deposited on the glass damages the transistors. In the embodiments of Table 1, the primary alkali oxide constituent is K₂O.

The glass compositions in the embodiments described herein further comprise B₂O₃. Like SiO₂, B₂O₃ contributes to the formation of the glass network. Conventionally, B₂O₃ may be added to a glass composition to decrease the viscosity of the glass composition. In some embodiments, the glass composition comprising B₂O₃ also has a high or desirable liquidus viscosity. In the embodiments described herein, B₂O₃ is generally present in the glass compositions in an amount from about 8 mol. % to about 20 mol. %, for example, from 9 mol. % to about 17 mol. from about 9.5 mol. % to about 17 mol. %, or from about 9.1 mol. % to about 16.8 mol. %.

RO preferably comprises alkaline earth metal oxides such as MgO, CaO, SrO and BaO, and optionally comprises ZnO, in any suitable ranges.

In addition to the glass formers (SiO₂, Al₂O₃, and B₂O₃), the glasses described herein may also include alkaline earth oxides. In some embodiments, at least one, two or three alkaline earth oxides are part of the glass composition, e.g., MgO, CaO, and BaO, and/or SrO. The alkaline earth oxides provide the glass with various properties important to melting, fining, forming, and ultimate use. Accordingly, to improve glass performance in these regards, in exemplary embodiment disclosed herein, the ratio of (MgO+CaO+SrO+BaO)/Al₂O₃ ratio is equal to or greater than about 10, or is equal to or greater than about 15, for example 10 to 5000, or 10 to 2750. In some embodiments, the ratio (MgO+CaO+SrO+BaO)/Al₂O₃ is at least 20, for example, in a range of from 20 to 75, 20 to 50, or 20 to 45. In some embodiments, the ratio of (MgO+CaO+SrO+BaO)/Al₂O₃ ratio is, for example, in a range of from 20 to 1000, 20 to 500, 20 to 100, 20 to 50, 20 to 42.5, 20 to 41, 20 to 40.5, 25 to 45, 25 to 41, 26 to 41, or 26 to 40.5. In some embodiments: 1000000≥(K₂O+Rb₂O+Cs₂O+MgO+CaO+SrO+BaO)/Al₂O₃≥10.

MgO may be optionally added to the glass composition in some embodiments. Examples of a suitable range of MgO include, but are not limited to, about 0 mol. % to about 20 mol. %, about 0 mol. % to about 19.9 mol. %, about 0.4 mol. % to about 20 mol. %, about 0.4 mol. % to about 19.9 mol. %, about 0.3 mol. % to about 20 mol. %, about 0.3 mol. % to about 19.9 mol. %, about 0.4 mol. % to about 20 mol. %, or about 0.4 mol. % to about 19.9 mol. %, In some embodiments, MgO has a content equal to or higher than 7 mol. %, for example, in a range of about 0.4 mol. % to about 19.9 mol. In some embodiments the amount of MgO is greater than the amount of Al₂O₃.

In some embodiments, SrO may has a content of 0 mlo. % to 17 mol. %, for example, in a range of about 10 mol. % to about 17 mol. %, 15 mol. % to about 17 mol. %, or about 16 mol. % to about 17 mol. %.

Examples of a suitable range of CaO include, but are not limited to, about 0 mol. % to about 17 mol. %, about 0.1 mol. % to about 17 mol. %, about 0.1 mol. % to about 16 mol. %.

In some embodiments, a % molar ratio of RO/Al₂O₃ is in a range of from about 10 to about 100, for example, from about 20 to about 50, from about 20 to about 45, or from about 25 to about 42. In some embodiments, the ratio of RO/Al₂O₃ between 26 and 40.5, or between 26.3 and 40.4.

The composition may comprise any other suitable ingredients such as SnO₂. SnO₂ may be in a suitable range, for example, from 0 mol. % to about 1 mol. %, or 0 mol. % to about 0.8 mol. %, from 0 mol. % to about 0.5 mol. %. In some embodiments, SnO₂ is present in an amount of from 0.01 mol. % to 1 mol. %, for example, from 0.05 mol. % to 1 mol. %, 0.1 mol. % to 0.75 mol. %. In some embodiments, SnO₂ is present in an amount of from 0.01 mol. % to 0.25 mol. %, for example, from 0.05 mol. % to 0.2 mol. %, 0.1 mol. % to 0.2 mol. %.

The present disclosure provides any suitable composition with different combinations of the ingredients and content ranges as described herein.

In some embodiments, an exemplary glass composition comprises:
about 50 mol. % to about 68.5 mol. % SiO₂,
greater than 0 mol. % to about 1.25 mol. % Al₂O₃ (e.g., 0.001 to 1 mol. % Al₂O₃, or 0.005 mol. % to 0.06 mol. % Al₂O₃),
about 5 mol. % to about 20 mol. % B₂O₃ (e.g., 9 mol. % to about 17 mol. % B₂O₃),
about 3.5 mol. % to about 17 mol. % K₂O₃ (e.g., 3.5 mol. % to about 15 mol. % K₂O₃);
0 mol. % to about 19.9 mol. % MgO,
0 mol. % to about 15.7 mol. % CaO,
0 mol. % to 16.5 mol. % MgO, and
0 mol. % to about 16.5 mol. % BaO; and
   the molar ratio of (K₂O+Rb₂O+Cs₂O+MgO+CaO+SrO+BaO)/Al₂O₃ is greater than 10, preferably greater than 20, for example 20 to 5000, or 20 to 2750, or 20 to 1000. Preferably the glass composition comprises no more than 2 mol. % of other components (e.g., no more than 1 mol. %, or even no more than 0.5 mol. %)

In some embodiments, an exemplary glass composition comprises:
about 50 mol. % to about 68.5 mol. % SiO₂,
greater than 0 mol. % to about 0.25 mol. % Al₂O₃,
about 9 mol. % to about 17 mol. % B₂O₃,
about 2 mol. % to about 18 mol. % of R₂O, wherein R₂O is an alkali metal
oxide selected from the group consisting of K₂O, Rb₂O, Cs₂O, and a combination thereof;
0 mol. % to about 12 mol. % MgO;
0 mol. % to about 10 mol. % CaO;
0 mol. % to about 16.5 mol. % SrO;
0 mol. % to about 16.5 mol. % BaO, and
   wherein the glass composition comprises about 10 mol. % to about 70 mol. % RO in total, and RO is selected from the group consisting MgO, CaO, SrO, BaO, and any combination thereof.

In some embodiments, the glass composition comprises about 15 mol. % to about 70 mol. % RO in total, and RO comprises MgO, CaO, SrO, BaO, and any combination thereof. In some embodiments, the glass composition comprises about 15.5 mol. % to about 68 mol. % RO in total, and RO comprises MgO, CaO, SrO, BaO, and any combination thereof.

In some embodiments, the alkali metal oxide (R₂O) is K₂O. Such a composition may comprise Rb₂O or Cs₂O, or any combination of K₂O, Rb₂O and Cs₂O. The composition may optionally comprise Li₂O. More preferably, the composition is substantially free of Li₂O.

In some embodiments, MgO may be in a range of about 0 mol. % to about 20 mol. %, and SrO is in a range of about 0 mol. % to about 17 mol. %. The molar ratio of RO/Al₂O₃ may be, for example, in a range of from about 30 to about 52, e.g., 32.5 to 51.5.

The glass composition provides both processing and performance advantages. For example, the glass composition has a low liquidus temperature (T_{liq}) and high liquidus viscosity. The liquidus temperature may be equal to or less than 1,300° C., for example, in a range of about 900° C. to 1,200° C.; or about 1,000° C. to 1,200° C.; about 900° C. to 1,185° C.; or about 1,000° C. to 1,185° C.; about 900° C. to 1,150° C.; or about 1,000° C. to 1,150° C.

The glass composition may have a liquidus viscosity equal to or higher than 100 Poise, for example, in a range of from about 200 kPoise to about 400 kPoise, from about 200 kPoise to about 600 kPoise, or from about 200 kPoise to about 800 kPoise. In some embodiments, the liquidus viscosity may be in the range of from 100 kPoise to 800 kPoise, for example, from about 100 kPoise to about 550 kPoise, or from about 200 kPoise to about 450 kPoise.

The glass composition has intermediate to coefficient of thermal expansion (CTE>75×10⁻⁷/° C., and in the embodiments of Table≥78×10⁻⁷/° C., for example, in a range of from about 75×10⁻⁷/° C. to about 93×10⁻⁷/° C. at a temperature from 20° C. to 300° C., or in a range of from about 78×10⁻⁷/° C. to about 95×10⁻⁷/° C.

In another aspect, the present disclosure also provides a method of making and a method of using the glass composition described herein, a glass article (or component) comprising such a glass composition, and a display device comprising the glass composition or a glass article having the glass composition.

Examples of a glass article include, but are not limited to a panel, a substrate, a cover, a backplane, or any other components used in an electronic device for display applications. In some embodiments, the glass article such as a substrate or a panel is optically transparent. Examples of the glass article include, but are not limited to, a flat or curved glass panel.

For example, in some embodiments, the glass composition or the glass substrate is a cover or backplane in an electronic device. In some embodiments, thin film resistors are built on or in contact with the glass composition. The thin film resistors may be amorphous silicon based or poly-crystalline silicon based. In some embodiments, the glass composition provided in the present disclosure is used as a substrate or a layer, in or on which amorphous silicon based transistors are disposed. Examples of the electronic devices include, but are not limited to, liquid crystal display (LCD), light emitting diode (LED) display, computer monitors, automated teller machines (ATMs), touch screen, and photovoltaic devices.

### Examples

The following examples are set forth below to illustrate the methods and results according to the disclosed subject matter. These examples are not intended to be inclusive of all embodiments of the subject matter disclosed herein, but rather to illustrate representative methods and results. These examples are not intended to exclude equivalents and variations of the present disclosure which are apparent to one skilled in the art.

Efforts have been made to ensure accuracy with respect to numbers (e.g., amounts, temperature, etc.) but some errors and deviations should be accounted for. Unless indicated otherwise, temperature is in ° C. or is at ambient temperature, and pressure is at or near atmospheric. The compositions themselves are given in mole percent (mol. %) on an oxide basis and have been normalized to 100%. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

The glass properties set forth in the tables were determined in accordance with techniques conventional in the glass art. Thus, the linear coefficient of thermal expansion (CTE) over the temperature range 25-300° C. is expressed in terms of x 10⁻⁷/° C., and the annealing point is expressed in terms of ° C. The CTE was determined following ASTM standard E228. The annealing point was determined from beam bending viscosity (BBV) measurement technique following ASTM standard C598, unless expressly indicated otherwise. The density in terms of grams/cm³ was measured via the Archimedes method (ASTM C693). The melting temperature in terms of ° C. (defined as the temperature at which the glass melt demonstrates a viscosity of 200 poises) was calculated employing a Fulcher equation fit to high temperature viscosity data measured via rotating cylinders viscometry (ASTM C965-81).

The liquidus temperature of the glass in terms of ° C. was measured using the standard gradient boat liquidus method of ASTM C829-81. This involves placing crushed glass particles in a platinum boat, placing the boat in a furnace having a region of gradient temperatures, heating the boat in an appropriate temperature region for 24 hours, and determining by means of microscopic examination the highest temperature at which crystals appear in the interior of the glass. More particularly, the glass sample is removed from the Pt boat in one piece and examined using polarized light microscopy to identify the location and nature of crystals which have formed against the Pt and air interfaces and in the interior of the sample. Because the gradient of the furnace is very well known, temperature vs. location can be well estimated, within 5-10° C. The temperature at which crystals are observed in the internal portion of the sample is taken to represent the liquidus of the glass (for the corresponding test period). Testing is sometimes carried out at longer times (e.g. 72 hours) to observe slower growing phases. The liquidus viscosity in poises was determined from the liquidus temperature and the coefficients of the Fulcher equation.

Young's modulus and shear modulus in terms of GPa, and Poisson's ratio were determined using a resonant ultrasonic spectroscopy (RUS) technique of the general type set forth in ASTM E1875-00e1.

Stress optical coefficient (SOC) values can be measured as set forth in Procedure C (Glass Disc Method) of ASTM standard C770-16, entitled “Standard Test Method for Measurement of Glass Stress-Optical Coefficient.”

The exemplary glasses of Table 1 were prepared using a commercial sand as a silica source, milled such that 90% by weight passed through a standard U.S. 100 mesh sieve. Alumina was the alumina source, periclase was the source for MgO, limestone the source for CaO, strontium carbonate, strontium nitrate or a mix thereof was the source for SrO, barium carbonate was the source for BaO, and tin (IV) oxide was the source for SnO₂. The raw materials were thoroughly mixed, and double melted in crucibles. The raw materials can be also mixed and then loaded into a platinum vessel suspended in a furnace heated by silicon carbide glowbars, melted and stirred for several hours at temperatures between 1,600 and 1,650° C., and delivered through an orifice at the base of the platinum vessel. The mixing and double melting procedures ensured homogeneity. The resulting patties of glass were annealed at or near the annealing point, and then subjected to various experimental methods to determine physical, viscous and liquidus attributes.

These methods are not unique, and the glass compositions can be prepared using standard methods well-known to those skilled in the art. Such methods include a continuous melting process, such as would be performed in a continuous melting process, wherein the melter used in the continuous melting process is heated by gas, by electric power, or combinations thereof.

Raw materials appropriate for producing exemplary glasses include commercially available sands as sources for SiO₂; alumina, aluminum hydroxide, hydrated forms of alumina, and various aluminosilicates, nitrates and halides as sources for Al₂O₃; boric acid, anhydrous boric acid and boric oxide as sources for B₂O₃; periclase, dolomite (also a source of CaO), magnesia, magnesium carbonate, magnesium hydroxide, and various forms of magnesium silicates, aluminosilicates, nitrates and halides as sources for MgO; limestone, aragonite, dolomite (also a source of MgO), wollastonite, and various forms of calcium silicates, aluminosilicates, nitrates and halides as sources for CaO; and oxides, carbonates, nitrates and halides of strontium and barium. If a chemical fining agent is desired, tin can be added as SnO₂, as a mixed oxide with another major glass component (e.g., CaSnO₃), or in oxidizing conditions as SnO, tin oxalate, tin halide, or other compounds of tin known to those skilled in the art.

The exemplary glass compositions contain SnO₂ as a fining agent, but other chemical fining agents could also be employed to obtain glass of sufficient quality for TFT substrate applications. For example, exemplary glasses could employ any one or combinations of As₂O₃, Sb₂O₃, CeO₂, Fe₂O₃, and halides as deliberate additions to facilitate fining, and any of these could be used in conjunction with the SnO₂ chemical fining agent shown in the examples. Of these, As₂O₃ and Sb₂O₃ are generally recognized as hazardous materials, subject to control in waste streams such as might be generated in the course of glass manufacture or in the processing of TFT panels. It is therefore desirable to limit the concentration of As₂O₃ and Sb₂O₃ individually or in combination to no more than 0.005 mol %.

In addition to the elements deliberately incorporated into exemplary glasses, nearly all stable elements in the periodic table are present in glasses at some level, either through low levels of contamination in the raw materials, through high-temperature erosion of refractories and precious metals in the manufacturing process, or through deliberate introduction at low levels to fine tune the attributes of the final glass. For example, zirconium may be introduced as a contaminant via interaction with zirconium-rich refractories. As a further example, platinum and rhodium may be introduced via interactions with precious metals. As a further example, iron may be introduced as a tramp in raw materials, or deliberately added to enhance control of gaseous inclusions. As a further example, manganese may be introduced to control color or to enhance control of gaseous inclusions.

Hydrogen is inevitably present in the form of the hydroxyl anion, OH, and its presence can be ascertained via standard infrared spectroscopy techniques. Dissolved hydroxyl ions significantly and nonlinearly impact the annealing point of exemplary glasses, and thus to obtain the desired annealing point it may be necessary to adjust the concentrations of major oxide components so as to compensate. Hydroxyl ion concentration can be controlled to some extent through choice of raw materials or choice of melting system. For example, boric acid is a major source of hydroxyls, and replacing boric acid with boric oxide can be a useful means to control hydroxyl concentration in the final glass. The same reasoning applies to other potential raw materials comprising hydroxyl ions, hydrates, or compounds comprising physisorbed or chemisorbed water molecules. If burners are used in the melting process, then hydroxyl ions can also be introduced through the combustion products from combustion of natural gas and related hydrocarbons, and thus it may be desirable to shift the energy used in melting from burners to electrodes to compensate. Alternatively, one might instead employ an iterative process of adjusting major oxide components so as to compensate for the deleterious impact of dissolved hydroxylions.

Sulfur is often present in natural gas, and likewise is a tramp component in many carbonate, nitrate, halide, and oxide raw materials. In the form of SO₂, sulfur can be a troublesome source of gaseous inclusions. The tendency to form SO₂-rich defects can be managed to a significant degree by controlling sulfur levels in the raw materials, and by incorporating low levels of comparatively reduced multivalent cations into the glass matrix. While not wishing to be bound by theory, it appears that SO₂-rich gaseous inclusions arise primarily through reduction of sulfate (SO₄⁼) dissolved in the glass.

The elevated barium concentrations of exemplary glasses appear to increase sulfur retention in the glass in early stages of melting, but as noted above, barium is required to obtain low liquidus temperature, and hence high liquidus viscosity. Deliberately controlling sulfur levels in raw materials to a low level is a useful means of reducing dissolved sulfur (presumably as sulfate) in the glass. In particular, sulfur is preferably less than 200 ppm by weight in the batch materials, and more preferably less than 100 ppm by weight in the batch materials.

Reduced multivalents can also be used to control the tendency of exemplary glasses to form SO₂ blisters. While not wishing to be bound to theory, these elements behave as potential electron donors that suppress the electromotive force for sulfate reduction. Sulfate reduction can be written in terms of a half reaction such as

SO₄⁼>SO₂+O₂+2e⁻

where e-denotes an electron. The “equilibrium constant” for the half reaction is

K_{eq}=[SO₂][O₂][e⁻]/[SO₄⁼]

where the brackets denote chemical activities. Ideally one would like to force the reaction so as to create sulfate from SO₂, O₂ and 2e⁻. Adding nitrates, peroxides, or other oxygen-rich raw materials may help, but also may work against sulfate reduction in the early stages of melting, which may counteract the benefits of adding them in the first place. SO₂ has very low solubility in most glasses, and so is impractical to add to the glass melting process. Electrons may be “added” through reduced multivalents. For example, an appropriate electron-donating half reaction for ferrous iron (Fe²⁺) is expressed as

2Fe²⁺→2Fe³⁺+2e⁻

This “activity” of electrons can force the sulfate reduction reaction to the left, stabilizing SO₄⁼ in the glass. Suitable reduced multivalents include, but are not limited to, Fe²⁺, Mn²⁺, Sn²⁺, Sb³⁺, As³⁺, V³⁺, Ti³⁺, and others familiar to those skilled in the art. In each case, it may be important to minimize the concentrations of such components so as to avoid deleterious impact on color of the glass, or in the case of As and Sb, to avoid adding such components at a high enough level so as to complication of waste management in an end-user's process.

In addition to the major oxides components of exemplary glasses, and the minor or tramp constituents noted above, halides may be present at various levels, either as contaminants introduced through the choice of raw materials, or as deliberate components used to eliminate gaseous inclusions in the glass. As a fining agent, halides may be incorporated at a level of about 0.4 mol % or less, though it is generally desirable to use lower amounts if possible to avoid corrosion of off-gas handling equipment. In some embodiments, the concentrations of individual halide elements are below about 200 ppm by weight for each individual halide, or below about 800 ppm by weight for the sum of all halide elements.

In addition to these major oxide components, minor and tramp components, multivalents and halide fining agents, it may be useful to incorporate low concentrations of other colorless oxide components to achieve desired physical, optical or viscoelastic properties. Such oxides include, but are not limited to, TiO₂, ZrO₂, HfO₂, Nb₂O₅, Ta₂O₅, MoO₃, WO₃, ZnO, In₂O₃, Ga₂O₃, Bi₂O₃, GeO₂, PbO, SeO₃, TeO₂, Y₂O₃, La₂O₃, Gd₂O₃, and others known to those skilled in the art. Through an iterative process of adjusting the relative proportions of the major oxide components of exemplary glasses, such colorless oxides can be added to a level of up to about 2 mol. %, for example, less than 0.5 mol. % without unacceptable impact to annealing point or liquidus viscosity.

Tables 1 and 2 show the compositions of Experimental Examples A-I. The measured property data of Examples A-I includes softening point, annealing point, Young's modulus, shear modulus, Poisson's ratio, and hardness are also listed in Tables 1 and 2. The modeled (calculated) Fulcher's viscosity coefficients and values are also provided.

TABLE 2
Glass compositions and properties.

| Analyzed (mol %) | Min | Max | A | B | C | D |
|---|---|---|---|---|---|---|
| SiO₂ | 51.2 | 68.3 | 61.0 | 54.7 | 56.5 | 51.2 |
| Al₂O₃ | 0.3 | 0.5 | 0.4 | 0.3 | 0.3 | 0.4 |
| B₂O₃ | 9.5 | 16.8 | 13.4 | 16.0 | 11.7 | 15.7 |
| K₂O | 3.5 | 14.0 | 9.2 | 13.3 | 13.7 | 12.5 |
| MgO | 0.4 | 19.9 | 15.7 | 15.4 | 17.1 | 19.9 |
| CaO | 0.1 | 15.7 | 0.1 | | 0.4 | 0.1 |
| SrO | 16.5 | 16.5 | | | | |
| BaO | 16.5 | 16.5 | | | | |
| SnO₂ | 0.1 | 0.2 | 0.1 | 0.1 | 0.1 | 0.1 |
| Sum | | | 100 | 100 | 100 | 100 |
| RO/Al₂O₃ | 32.9 | 51.5 | 45 | 47 | 51 | 51 |
| R₂O/Al₂O₃ | 26.3 | 40.4 | 26 | 40 | 40 | 32 |
| (RO + R₂O)/Al₂O₃ | 63.4 | 91.8 | 71 | 87 | 92 | 83 |
| Refractive Index (RI) at | 1.502 | 1.538 | 1.5087 | | 1.5099 | 1.5017 |
| 589.3 nm | | | | | | |
| Density (g/cm³) | 2.413 | 3.083 | 2.413 | 2.427 | 2.435 | 2.435 |
| Strain Point (° C., Beam | 530 | 651 | 651 | | | 530 |
| Bending Viscosity) | | | | | | |
| Anneal Point (° C., Beam | 569 | 704 | 704 | | | 569 |
| Bending Viscosity) | | | | | | |
| Softening Point (° C., | 750 | 750 | 750 | | | |
| Parallel Plate Viscosity) | | | | | | |
| Softening Point (° C., | | | | | | 711 |
| Fiber Elongation) | | | | | | |
| Coefficient of Thermal | 78 | 93 | 78 | | 93 | 90 |
| Expansion (×10⁻⁷,/° C.) @ | | | | | | |
| 300° C. | | | | | | |
| Poissons Ratio (Resonant | 0.234 | 0.249 | 0.234 | | 0.234 | 0.244 |
| Ultrasound Spectroscopy) | | | | | | |
| Young's Modulus (GPa, | 63.2 | 71.4 | 69.8 | | 63.2 | 64.7 |
| Resonant Ultrasound | | | | | | |
| Spectroscopy) | | | | | | |
| Shear Modulus (GPa, | 23.2 | 28.9 | 28.3 | | 25.6 | 23.2 |
| Resonant Ultrasound | | | | | | |
| Spectroscopy) | | | | | | |
| Vicker's Hardness (kgf/mm²) | | | 567 | | | |
| st dev | | | 14.6 | | | |
| % covar | | | 2.6 | | | |
| Viscosity: Modelled | | | −3.311 | −3.789 | −3.489 | −3.842 |
| Fulcher's A Coefficient | | | | | | |
| Viscosity: Modelled | | | 6509 | 6389 | 6129 | 6258 |
| Fulcher's B Coefficient | | | | | | |
| Viscosity: Modelled | | | 176.2 | 174.2 | 202.9 | 186.0 |
| Fulcher's T₀ Coefficient | | | | | | |
| Viscosity: R² from model | | | 0.999 | 0.999 | 0.999 | 0.9995 |

TABLE 3
Glass compositions and properties.

| Analyzed (mol %) | E | F | G | H | I |
|---|---|---|---|---|---|
| SiO₂ | 54.8 | 53.3 | 53.0 | 53.4 | 68.3 |
| Al₂O₃ | 0.3 | 0.5 | 0.4 | 0.4 | 0.007 |
| B₂O₃ | 16.2 | 16.8 | 16.0 | 15.6 | 9.5 |
| K₂O | 12.3 | 14.0 | 13.8 | 13.8 | 3.5 |
| MgO | 0.4 | | | | 18.2 |
| CaO | 15.7 | 15.1 | 0.1 | | 0.1 |
| SrO | | | 16.5 | | |
| BaO | | | | 16.5 | |
| SnO₂ | 0.1 | 0.1 | 0.2 | 0.2 | 0.1 |
| Sum | 100 | 100 | 100 | 100 | 100 |
| RO/Al₂O₃ | 49 | 33 | 42 | 43 | 2614 |
| R₂O/Al₂O₃ | 37 | 31 | 35 | 36 | 500 |
| (RO + R₂O)/Al₂O₃ | 86 | 63 | 78 | 80 | 3114 |
| Refractive Index (RI) at 589.3 nm | 1.5383 | | | | |
| Density (g/cm³) | 2.542 | 2.548 | 2.823 | 3.083 | |
| Strain Point (° C., Beam Bending Viscosity) | 548 | | | | |
| Anneal Point (° C., Beam Bending | 586 | | | | |
| Viscosity) | | | | | |
| Poissons Ratio (Resonant Ultrasound | 0.240 | 0.247 | 0.249 | 0.249 | |
| Spectroscopy) | | | | | |
| Young's Modulus (GPa, Resonant | 71.4 | 70.3 | 70.6 | 67.0 | |
| Ultrasound Spectroscopy) | | | | | |
| Shear Modulus (GPa, Resonant | 28.8 | 28.9 | 28.3 | 26.8 | |
| Ultrasound Spectroscopy) | | | | | |
| Internal Liquidus Temperature (° C.) | | | | | 1295 |
| Liquidus Phase | | | | | Forsterite |
| Viscosity: Modelled Fulcher's A | −5.368 | −5.322 | −6.344 | −5.737 | −3.116 |
| Coefficient | | | | | |
| Viscosity: Modelled Fulcher's B | 7350 | 7343 | 8441 | 8529 | 6869 |
| Coefficient | | | | | |
| Viscosity: Modelled Fulcher's T₀ | 142. | 129 | 118 | 49.3 | 201 |
| Coefficient | | | | | |
| Viscosity: R² from model | 0.999 | 0.999 | 0.999 | 0.9997 | 0.999 |
| Liquidus Viscosity (P) | | | | | 1461 |

Tables 1 and 2 define the compositions and properties of some exemplary embodiments described herein. The compositions are unique relative to typical glass compositions because of low alumina concentrations and high modifier/alumina ratios. In terms of properties, these compositions have intermediate to high coefficients of thermal expansion (CTE, at 0-300° C.). Intermediate to high CTE values allow these glass compositions to be strengthened via lamination with a second glass cladding that has a much lower CTE. Mismatched core-clad CTEs strengthens laminate articles during the typical cooling process during manufacturing. This CTE mismatched strengthening process provides a significant cost savings over chemically or thermally strengthened glasses.

Intermediate to high CTE glasses can be utilized in applications that require CTE matching with various other materials of thicknesses ranging from thin film-like thicknesses (˜100 nm-thick layers) to much more substantial mm-thick layers. In the cases considered here, where the described articles are used as substrates for thin film transistors, CTE matching with metal films is critical to preventing delamination when the substrate and TFT stack undergoes low temperature thermal cycling.

Although the subject matter has been described in terms of exemplary embodiments, it is not limited thereto. Rather, the appended claims should be construed broadly, to include other variants and embodiments, which may be made by those skilled in the art.

1. A glass composition comprising:
about 50 mol. % to about 73 mol. % SiO₂;
greater than 0 mol. % to about 1.25 mol. % Al₂O₃;
about 5 mol. % to about 20 mol. % B₂O₃;
about 3.5 mol. % to about 17 mol. % K₂O;
0 mol. % to about 20 mol. % MgO;
0 mol. % to about 20 mol. % CaO;
0 mol. % to about 20 mol. % SrO;
0 mol. % to about 20 mol. % BaO; and
wherein the molar ratio (K₂O+Rb₂O+Cs₂O+MgO+CaO+SrO+BaO)/Al₂O₃≥10.

2. The glass composition of claim 1, wherein
1000000≥K₂O+Rb₂O+Cs₂O+MgO+CaO+SrO+BaO)/Al₂O₃≥10.

3. The glass composition of claim 1 or 2, wherein 1 glass composition further comprises about 0 mol. % to about 1 mol. % SnO₂.

4. A glass composition comprising:
about 50 mol. % to about 73 mol. % SiO₂,
greater than 0 mol. % to about 1.25 mol. % Al₂O₃,
about 5 mol. % to about 20 mol. % B₂O₃,
about 3.5 mol. % to about 17 mol. % K₂O₃,
0 mol. % to about 19.9 mol. % MgO,
0 mol. % to about 15.7 mol. % CaO,
0 mol. % to about 16.5 mol. % SrO, and
0 mol. % to about 16.5 mol. % BaO,
wherein the ratio (RO+R₂O)/Al₂O₃ is greater than 10.

5. The glass composition of claim 4, wherein:
(i) the ratio of RO to Al₂O₃ is greater than 10; and
(i) the ratio of R₂Oto Al₂O₃ is greater than 10.

6. The glass composition of claim 4, where molar ratios:
(i) 1000≥RO/Al₂O₃≥20; and
(i) 1000≥R₂O/Al₂O₃≥20.

7. The glass composition of claim 4, wherein
(RO+R₂O)/Al₂O₃ is between 60 and 95
R₂O/Al₂O₃ is between 20 and 50; and
RO/Al₂O₃ is between 25 and 55.

8. The glass composition of claim 4, wherein
(RO+R₂O)/Al₂O₃ is between 60 and 95;
R₂O/Al₂O₃ is between 25 and 42; and
RO/Al₂O₃ is between 30 and 52.

9. The glass composition of claim 1, having Coefficient of Thermal Expansion (CTE) of at least 78×10⁻⁷° C. at 300° C.

10. The glass composition of claim 1, having softening points not greater than 800° C.

11. The glass composition of claim 1, wherein the glass composition comprises the following characteristics

| Characteristics | Minimum | Maximum |
|---|---|---|
| Refractive Index at 589.3 nm | 1.5 | 1.55 |
| Density (g/cm³) | 2.4 | 3.1 |
| Strain Point (° C., Beam Bending Viscosity) | 525 | 655 |
| Anneal Point (° C., Beam Bending Viscosity) | 565 | 710 |
| Coefficient of Thermal Expansion (×10⁻⁷, /° C.) at 300° C. | 78 | 95 |
| Poissons Ratio | 0.23 | 0.25 |
| Young's Modulus (GPa) | 63 | 72 |
| Shear Modulus (GPa) | 23 | 29 |

12. The glass composition of claim 11, wherein the glass composition comprises the following characteristics

| Characteristics | Minimum | Maximum |
|---|---|---|
| Refractive Index at 589.3 nm | 1.502 | 1.538 |
| Density (g/cm³) | 2.413 | 3.083 |
| Strain Point (° C., Beam Bending Viscosity) | 530 | 651 |
| Anneal Point (° C., Beam Bending Viscosity) | 569 | 704 |
| Coefficient of Thermal Expansion (×10⁻⁷, /° C.) at 300° C. | 78 | 93 |
| Poissons Ratio | 0.234 | 0.249 |
| Young's Modulus (GPa) | 63.2 | 71.4 |
| Shear Modulus (GPa) | 23.2 | 28.9 |

13. A glass article comprising the glass composition of claim 1.

14. A display device comprising the glass composition of claim 1 or a glass substrate comprising the glass composition of claim 1.

15. The display device of claim 14, wherein the glass composition or the glass substrate is a cover or backplane in an electronic device for display application.

16. The glass composition of claim 4, wherein R₂O is an alkali metal oxide.

17. The glass composition of claim 4, wherein R₂O is K₂O.

18. The glass composition of claim 17, wherein R₂O is not Na₂O.

19. The glass composition of claim 4 comprises:
about 50 mol. % to about 68.5 mol. % SiO₂,
greater than 0 mol. % to about 1.25 mol. % Al₂O₃,
about 5 mol. % to about 20 mol. % B₂O₃,
about 3.5 mol. % to about 17 mol. % K₂O₃,
0 mol. % to about 19.9 mol. % MgO,
0 mol. % to about 15.7 mol. % CaO,
0 mol. % to 16.5 mol. % MgO), and
0 mol. % to about 16.5 mol. % BaO; and wherein
the molar ratio of (K₂O+Rb₂O+Cs₂O+MgO+CaO+SrO+BaO)/Al₂O₃ is greater than 10.

20. The glass composition of claim 19, wherein the glass composition comprises no more than 2 mol. % of other components.

21. The glass composition comprising:
about 50 mol. % to about 68.5 mol. % SiO₂,
greater than 0 mol. % to about 0.25 mol. % Al₂O₃,
about 9 mol. % to about 17 mol. % B₂O₃,
about 2 mol. % to about 18 mol. % of R₂O, wherein R₂O is an alkali metal oxide selected from the group consisting of K₂O, Rb₂O, Cs₂O, and a combination thereof;
0 mol. % to about 12 mol. % MgO;
0 mol. % to about 10 mol. % CaO;
0 mol. % to about 16.5 mol. % SrO;
0 mol. % to about 16.5 mol. % BaO,
wherein the glass composition comprises about 10 mol. % to about 70 mol. % RO in total, and RO is selected from the group consisting MgO, CaO, SrO, BaO, and any combination thereof; and the glass composition comprises no more than 2 mol. % of other components.

22. A glass article comprising the glass composition of claim 1.

23. A display device comprising the glass composition of claim 1 or a glass substrate comprising the glass composition of claim 1.

24. The display device of claim 23, wherein the glass composition or the glass substrate is a cover or backplane in an electronic device for display application.

25. (canceled)
